(19) United States
(12) Patent Application Publication
(10) Pub. No.: US 2012/0027185 A1
(43) Pub. Date: Feb. 2, 2012

(54) AUTOMATED MARKETING SYSTEM UTILIZING EMAIL TRIGGER FOR TELEPHONE CONTACT

(76) Inventor: Chris Fuelling, Miami, FL (US)

(21) Appl. No.: 12/843,881

(22) Filed: Jul. 27, 2010

(51) Int. Cl. H04M 11/00

(52) U.S. Cl. 379/88.13

(57) ABSTRACT

A method on a computer system for facilitating communications with customers over a communications network is provided. The method includes collecting a plurality of email addresses of customers from a customer database, wherein a telephone number is associated with each email address that was collected from the customer database. The method further includes generating and sending an email to each customer whose email address was collected from the customer database, wherein each email includes customized program logic that sends a message to the computer system when a customer receiving the email interacts with it and wherein the message includes a unique identifier for the customer. The method further includes receiving a message from a first customer, reading the unique identifier embedded in the message, looking up the first customer's phone number in the customer database using the unique identifier and initiating a telephone call to the first customer.

### BACKGROUND OF THE INVENTION

1. Field of the Invention

The present invention relates to the field of marketing and, more specifically, the present invention relates to the field of automated marketing efforts utilizing computing devices over a communications network.

2. Description of the Related Art

Historically, the only methods for advertisers and mass communicators to showcase their products and services have been print media and in-person advertising and marketing. With the birth of the electronic age, however, a plethora of additional options became available for businesses seeking to advance their brands. The emergence of radio and television, for example, afforded advertisers access to previously unavailable technologies—radio frequency-transmitted audio and video. Likewise, the widespread adoption of telephone technology opened the door for more personal communications between an advertiser and consumers. In the same thread, the Internet now provides advertisers additional venues for reaching consumers. Email, for example, is now a well-known advertising method on the Web.

The simultaneous use of a combination of email and telephone for marketing purposes, however, is currently under-used. Ideally, a marketing email to a consumer will spur a telephone call from the consumer. With the rise of spam and unwanted email, however, it is becoming increasingly difficult to get consumers to read and interact with a marketing email. Various creative approaches to online advertising and communications using email and telephone, however, currently exist. One common approach involves sending an email that asks a consumer to call the advertiser for more information about a product or service. This approach is problematic because it requires a consumer to proactively make a telephone call, which reduces the effectiveness of this marketing ploy. Busy consumers are not likely to take time out of their day to make a telephone call. For this reason, marketing approaches that require little action by the consumer are optimal. Another approach involves sending an email that asks a consumer to enter his telephone number to receive a call from the advertiser. Again, this approach is not optimal because it requires a proactive consumer that is not very busy. As a result, the effectiveness of this approach is limited.

What is needed is a system and method for improving the problems with the prior art, and more particularly for a more efficient method and system for automating the process of marketing to consumers using email and the telephone system.

### BRIEF SUMMARY OF THE INVENTION

Embodiments of the present invention address deficiencies of the art in respect to computing and provide a novel and non-obvious method for automated marketing over a communications network. In an embodiment of the invention, a method on a computer system for facilitating communications with customers over a communications network can be provided. The method can include collecting a plurality of email addresses of customers from a customer database, wherein a telephone number is associated with each email address that was collected from the customer database. The method can further include generating and sending an email to each customer whose email address was collected from the customer database, wherein each email includes customized program logic that sends a message to the computer system when a customer receiving the email interacts with it and wherein the message includes a unique identifier for the customer. The method can further include receiving a message from a first customer due to the first customer's interaction with an email received by the first customer and reading the unique identifier embedded in the message, looking up the first customer's phone number in the customer database using the unique identifier and initiating a telephone call to the first customer using the first customer's telephone number.

In another embodiment of the invention, a computer system for facilitating communications with customers over a communications network can be provided. The computer system can include a processor configured for collecting a plurality of email addresses of customers from a customer database, wherein a telephone number is associated with each email address that was collected from the customer database, generating and sending an email to each customer whose email address was collected from the customer database, wherein each email includes customized program logic that sends a message to the computer system when a customer receiving the email interacts with it and wherein the message includes a unique identifier for the customer, receiving a message from a first customer due to the first customer's interaction with an email received by the first customer and reading the unique identifier embedded in the message and looking up the first customer's phone number in the customer database using the unique identifier. The computer system can further include a telephony system configured for initiating a telephone call to the first customer using the first customer's telephone number.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of an automated marketing system utilizing email to trigger telephone contact with customers, in accordance with one embodiment of the present invention.

FIG. 2 is a flow chart describing the control flow of the overall process of automated marketing utilizing email to trigger telephone contact with customers, in accordance with one embodiment of the present invention.

### DETAILED DESCRIPTION OF THE INVENTION

The present invention improves upon the problems with the prior art by providing a more effective method and system for communicating with customers using email and the telephone system. The present invention solves the problems of the prior art by providing a marketing system that requires little, if any, proactive steps by the customer receiving an email. The aforementioned method and system of the present invention does not require any dialing by the customer or any entering of information in order to receive a marketing telephone call, thereby increasing the effectiveness of this marketing method. By initiating a telephone call simply by detecting the customer's interaction with an email, such as clicking on a link, opening an email, or not opening an email, the present invention has reduced down to one, simple action the necessary acts required for the customer to receive an automated telephone call that plays a pre-recorded call or bridges a live representative to the customer. A customer's interaction with a marketing email, therefore, acts as the trigger for an automated telephone call. As such, the method appears seamless and expedient to the customer.

The present invention further improves upon the prior art by combining the use of a live representative for a marketing call with the use of prerecorded audio files. Specifically, an audio file is used to interact initially with the customer, though the customer is given a choice to interact with a live representative upon pressing a number or button. This is advantageous as it reduces the amount of live representatives necessary and eliminates the need for live representatives to handle calls with customers that are not interested in speaking with a live representative.

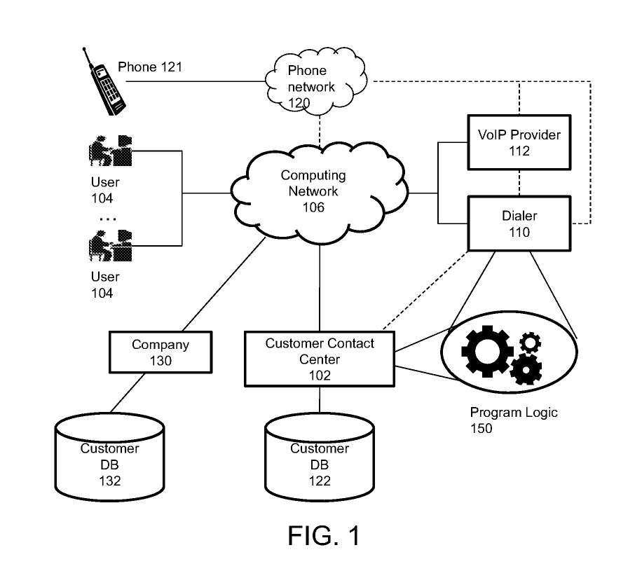

Referring now to the drawing figures in which like reference designators refer to like elements, there is shown in FIG. 1 an illustration of a block diagram showing the network architecture of a system and method of an automated marketing system utilizing email to trigger telephone contact with customers, in accordance with the principles of the present invention. FIG. 1 shows an embodiment of the present invention wherein multiple users 104, each comprising an individual and a computer, interact with customer contact center 102 over a network 106, which can be a packet switched network such as the Internet or the World Wide Web. The computers of users 104 can be desktops, laptops, handheld computers, smart phones, tablet computers or the like.

Customer contact center 102 comprises one or more servers or computer systems configured to execute the methods of the present invention, including the dissemination of marketing emails to users 104, the detection of a user 104 interaction with an email and the initiation of a telephone call with the user 104 using dialer 110, as defined in greater detail with reference to FIG. 1 below. Customer contact center 102 is coupled with customer database 122, which acts a repository for data records pertaining to customers of contact center 102. Each customer data record in database 122 may, for example, include a user's name, address, home phone number, mobile phone number, email address, age, sex, race, place of employment, income data, marital status, buying preferences, past purchase history, or the like. As explained in greater detail below, data from database 122 can be read via text-to-speech to a live representative prior to a customer call being bridged to the live representative.

FIG. 1 further shows user 104 has access to a telephone 121 connected to a phone network 120, which may be the public switched telephone system or a cellular phone system, via a wired or wireless connection. A voice over Internet Protocol (VoIP) provider 112 may interface with the phone network 120 to initiate telephone calls between a user 104 and either dialer 110 or contact center 102 or both. The VoIP provider 112 is further connected with the network 106.

Dialer 110 is a server or computer system that acts as a telephony system for initiating telephone calls between a user 104 and either dialer 110 or contact center 102 or both. The dialer 110 may interface directly with the phone network 120 or indirectly via VoIP provider 112. With regard to its interactions with customer contact center 102, the dialer 110 may interface with contact center 102 directly or via network 106. Likewise, the dialer 110 may interface with VoIP provider 112 directly or via network 106.

Customer contact center 102 includes program logic 150 comprising computer source code, object code, executable code, scripting language code and/or interpreted language code that is compiled to produce computer instructions that perform various functions of the present invention. Program logic 150 may reside solely on one or more computers of the customer contact center 102, or may be distributed between one or more computers of the customer contact center 102 and any one of the computers of dialer 110. In one alternative of the present invention, the program logic 150 is a client-server application having a client portion that resides on client computers 104 and a server application that resides in customer contact center 102.

Note that although customer contact center 102 is shown as a single and independent entity, in one embodiment of the present invention, the functions of customer contact center 102, and program logic 150 by extension, may be integrated with the functions of dialer 110 and VoIP provider 112. Further, customer contact center 102 and its functionality encompassed by program logic 150, according to one embodiment of the present invention, can be realized in a centralized fashion in one computer system or in a distributed fashion where different elements are spread across several interconnected computer systems.

In one embodiment of the present invention, the functionality of customer contact center 102 and dialer 110 is provided to companies 130 or other business entities via an Application Service Provider (ASP) paradigm, where the functions of center 102 and dialer 110 are hosted remotely from the company 130 and provided over the network 106. In this embodiment, it is necessary for the company 130 to upload its customer database information to the customer database 122. In cases where a company 130 or other business entity chooses not to upload its customer database information to the database 122, the center 102 may directly access the company's database 132 over network 106, thereby eliminating the need for the center 102 to house the company's data in its own database 122. This solution allows the functionality of customer contact center 102 and dialer 110 to execute while still honoring the information security demands of a company 130.

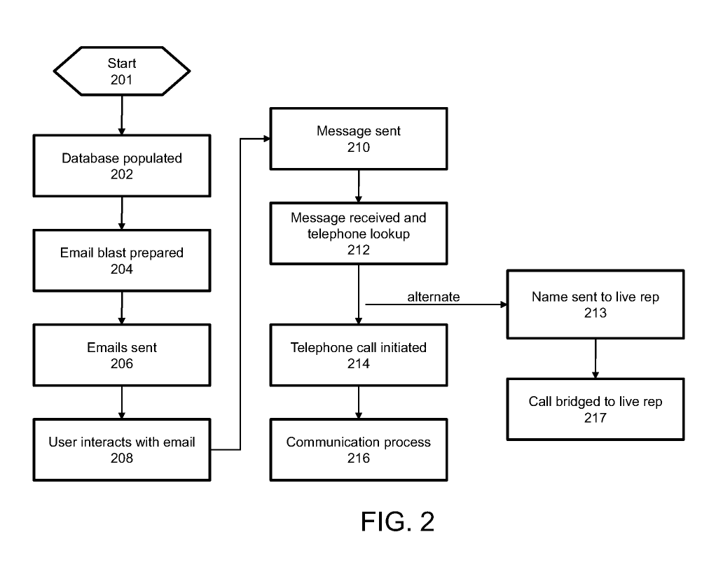

FIG. 2 is a flow chart describing the control flow of the overall process of automated marketing utilizing email to trigger telephone contact with customers, in accordance with one embodiment of the present invention. The flow chart of FIG. 2 describes the process undertaken by customer contact center 102 to initiate contact with users 104, using the system of the present invention. The flow chart of FIG. 2 is described in association with FIG. 1. The flow chart of FIG. 2 starts with step 201 and immediately moves to step 202.

In a first optional step 202, a company 130 uploads its customer database information to database 122, which includes a plurality of customer data records, wherein each data record includes at least an email address and a telephone number for each customer. Alternatively, the customer contact center 102 directly accesses over network 106 the customer database 132 located at company 130.

Next in step 204, the customer contact center 102 utilizes the data in customer database 122 (or, alternatively, database 132) to prepare an email blast, i.e., an electronic mailing, sent all at once to a large mailing list of customers. The electronic mailing may include text, images, video and/or source code that advertises or markets goods or services.

More specifically, the customer contact center 102 generates a custom email to each customer, wherein the custom portion of each email includes program logic configured to send a message to center 102 and/or dialer 110 via network 106 when the user 104 executes a particular interaction with the email. This interaction may include opening the email, clicking on a link or image in the email, hovering over a certain area of the email or pressing or sliding an interface widget such as a button, or the like. In short, the user interaction with the email acts as a trigger for the subsequent telephone communication. In one embodiment, the custom email is generated using PHP, CSS (Cascading Style Sheets), DOM (Document Object Model), JavaScript, XPCOM (Cross-Platform Component Object Model), XPConnect, XPI (Cross-Platform Installer), XUL (XML User Interface Language) any similar scripting language or any combination of the above.

In step 206, the email blast is executed, thereby sending a plurality of emails to a set of users 104. In step 208, a user 104 clicks on a link in the email he received. In step 210, the program logic in the email detects the click and sends a message, such as an HTTP request, from user 104 to center 102 or dialer 110 via network 106. The message includes a unique identifier for the user 104. In step 212, the program logic 150 in either center 102 or dialer 110 (or both) receives the message, reads the unique identifier within it and looks up the record of the identified customer in the customer database 122 (or, alternatively, database 132).

In step 214, the program logic 150 utilizes the telephone number of the user 104, garnered during the database lookup of step 212, to initiate a call to the phone 121 of user 104. Step 214 may comprise a direct connection to phone network 120 by dialer 110 or may enlist the use of VoIP provider 112 to initiate the telephone call.

In step 216, the customer communication process is executed. In one embodiment, the process of step 216 entails the center 102 sending one or more audio files, such as a .WAV file, to the dialer 110, which plays the audio file when the user 104 picks up the phone 121. The user 104 may be asked by the audio file if he desires to speak to a live representative if he presses a certain number. If so, the user 104 is connected to a live representative. If the dialer 110 reaches a voicemail or answering machine, the dialer 110 plays a separate audio file used for voicemails and answering machines.

In one alternative of the present invention, the process of step 214 is preceded by step 213, wherein the name of the user 104 (or any other data associated with the record of user 104 in database 122 or 132, as looked up by program logic 150 in step 212) is converted to speech using a text-to-speech converter and a telephone call to a live customer representative is established. Step 213 may comprise a direct connection to phone network 120 by dialer 110 or may enlist the use of VoIP provider 112 to initiate the telephone call. In step 213, the user's name, company, or other data required by the live customer representative is played for the customer representative so the representative is familiar with the user before the representative is connected to the user. In this alternative, in a next step 217, the program logic 150 utilizes the telephone number of the user 104, garnered during the database lookup of step 212, to bridge a call between the live customer representative and the phone 121 of user 104. If the dialer 110 reaches a voicemail or answering machine, the customer representative can press a certain key to initiate playing an audio file used for voicemails and answering machines.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data and instructions from the computer readable medium.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method on a computer system for facilitating communications with customers over a communications network, comprising:
collecting a plurality of email addresses of customers from a customer database, wherein a telephone number is associated with each email address that was collected from the customer database;
generating and sending an email to each customer whose email address was collected from the customer database, wherein each email includes customized program logic that sends a message to the computer system when a customer receiving the email interacts with it and wherein the message includes a unique identifier for the customer;
receiving a message from a first customer due to the first customer's interaction with an email received by the first customer and reading the unique identifier embedded in the message;
looking up the first customer's phone number in the customer database using the unique identifier; and
initiating a telephone call to the first customer using the first customer's telephone number.

2. The method of claim 1, wherein the steps of generating and sending further comprise:
generating and sending an email to each customer whose email address was collected from the customer database, wherein each email includes customized program logic that sends a message to the computer system when a customer clicks on a link in the email or opens the email and wherein the message includes a unique identifier for the customer.

3. The method of claim 2, wherein the step of receiving a message further comprises:
receiving a message from a first customer due to the first customer clicking on a link in the email received by the first customer and reading the unique identifier embedded in the message.

4. The method of claim 3, further comprising:
playing a first audio file if the first customer answers the telephone call, wherein the first audio file asks the first customer to press a predefined number if he desires to speak to a live representative.

5. The method of claim 4, further comprising:
bridging the telephone call to a live representative if the first customer presses the predefined number.

6. The method of claim 3, further comprising:
playing a second audio file if a voicemail or answering machine answers the telephone call, wherein the second audio file states the marketing nature of the telephone call.

7. The method of claim 3, further comprising:
bridging the telephone call to a live representative.

8. A computer system for facilitating communications with customers over a communications network, comprising:
a processor configured for:
collecting a plurality of email addresses of customers from a customer database, wherein a telephone number is associated with each email address that was collected from the customer database;
generating and sending an email to each customer whose email address was collected from the customer database, wherein each email includes customized program logic that sends a message to the computer system when a customer receiving the email interacts with it and wherein the message includes a unique identifier for the customer;
receiving a message from a first customer due to the first customer's interaction with an email received by the first customer and reading the unique identifier embedded in the message; and
looking up the first customer's phone number in the customer database using the unique identifier; and
a telephony system configured for initiating a telephone call to the first customer using the first customer's telephone number.

9. The computer system of claim 8, wherein the customized program logic sends a message to the computer system when a customer clicks on a link in the email or opens the email.

10. The computer system of claim 9, wherein the processor receives a message from a first customer due to the first customer clicking on a link in the email received by the first customer.

11. The computer system of claim 10, wherein the telephony system is further configured for:
playing a first audio file if the first customer answers the telephone call, wherein the first audio file asks the first customer to press a predefined number if he desires to speak to a live representative.

12. The computer system of claim 11, wherein the telephony system is further configured for:
bridging the telephone call to a live representative if the first customer presses the predefined number.

13. The computer system of claim 10, wherein the telephony system is further configured for:
playing a second audio file if a voicemail or answering machine answers the telephone call, wherein the second audio file states the marketing nature of the telephone call.

14. The computer system of claim 10, wherein the telephony system is further configured for:
bridging the telephone call to a live representative.

15. A method on a computer system for facilitating communications with customers over a communications network, comprising:
collecting a plurality of email addresses of customers from a customer database, wherein a telephone number and a name is associated with each email address that was collected from the customer database;
generating and sending an email to each customer whose email address was collected from the customer database, wherein each email includes customized program logic that sends a message to the computer system when a customer receiving the email interacts with it and wherein the message includes a unique identifier for the customer;
receiving a message from a first customer due to the first customer's interaction with an email received by the first customer and reading the unique identifier embedded in the message;
looking up the first customer's phone number and name in the customer database using the unique identifier;
generating a first audio file comprising a speech representation of the first customer's name;
initiating a telephone call to a live representative;
playing the first audio file for the live representative; and
bridging the telephone call to the first customer using the first customer's telephone number.

16. The method of claim 15, further comprising:
playing a second audio file for the first customer if a voicemail or answering machine answers the telephone call, wherein the second audio file states the marketing nature of the telephone call.
